(19) United States
(12) Patent Application Publication
(10) Pub. No.: US 2026/0099992 A1
(43) Pub. Date: Apr. 9, 2026

(54) TEMPORAL INFORMATION IN LOW RESOLUTION Z (LRZ) TO REDUCE WORKLOADS FOR DEPTH DISABLEMENT

(71) Applicant: QUALCOMM Incorporated, San Diego, CA (US)

(72) Inventors: Xiayang ZHAO, San Diego, CA (US); Jian LIANG, San Diego, CA (US); Tao WANG, Sunnyvale, CA (US); Xuefeng TANG, San Diego, CA (US); Andrew Evan GRUBER, Arlington, MA (US); Ruihao ZHANG, San Diego, CA (US); Junmei SHAO, San Diego, CA (US)

(21) Appl. No.: 18/911,147

(22) Filed: Oct. 9, 2024

(51) Int. Cl. G06T 15/40; G06T 1/20; G06T 17/20

(52) U.S. Cl. CPC G06T 15/405; G06T 1/20; G06T 17/20

(57) ABSTRACT

Aspects presented herein relate to methods and devices for graphics processing including an apparatus, e.g., a graphics processor. The apparatus may obtain, from an application, an indication of an image including a plurality of primitives. The apparatus may also detect that the application does not indicate a depth value for each of the plurality of primitives in the image. Further, the apparatus may determine, based on the detection, the depth value for each of the plurality of primitives. The apparatus may also sort the plurality of primitives in a primitive depth order based on the depth value for each of the plurality of primitives.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor or display processing unit (DPU).

A graphics processor of a device may be configured to perform the processes in a graphics processing pipeline. Further, graphics processors may be utilized to perform graphics rendering. However, there has developed an increased need for improved rendering in graphics processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processor, a graphics processing unit (GPU), a central processing unit (CPU), an application, or any apparatus that may perform for graphics processing. The apparatus may obtain, from an application, an indication of an image including a plurality of primitives. The apparatus may also configure a primitive mesh based on the plurality of primitives in the image, where the image is a two-dimensional (2D) image or a three-dimensional (3D) image. The apparatus may also detect that the application does not indicate a depth value for each of the plurality of primitives in the image. Additionally, the apparatus may output an indication that the application does not indicate the depth value for each of the plurality of primitives in the image. The apparatus may also determine, based on the detection, the depth value for each of the plurality of primitives. Moreover, the apparatus may sort the plurality of primitives in a primitive depth order based on the depth value for each of the plurality of primitives. The apparatus may also update a depth buffer based on the primitive depth order for the plurality of primitives, where the depth buffer is a low-resolution Z (LRZ) depth buffer, where the depth value is an LRZ depth value. Further, the apparatus may output an indication of the primitive depth order for the plurality of primitives.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processing unit (GPU) in accordance with one or more techniques of this disclosure.

FIG. 3 is a diagram illustrating example processing components in accordance with one or more techniques of this disclosure.

FIG. 4 is a diagram illustrating an example image or surface in accordance with one or more techniques of this disclosure.

FIG. 5 is a diagram illustrating an example culling process in accordance with one or more techniques of this disclosure.

FIG. 6 is a diagram illustrating an example clipping process in accordance with one or more techniques of this disclosure.

FIG. 7 is a diagram illustrating an example primitive clipping operation in accordance with one or more techniques of this disclosure.

FIG. 8 is a diagram illustrating an example filtering sequence in accordance with one or more techniques of this disclosure.

FIG. 9 is a diagram illustrating an example sorting process in accordance with one or more techniques of this disclosure.

FIG. 10 is a diagram illustrating an example sorting process in accordance with one or more techniques of this disclosure.

FIG. 11 is a diagram illustrating an example sorting process in accordance with one or more techniques of this disclosure.

FIG. 12 is a communication flow diagram illustrating example communications between a GPU, an application, and a memory in accordance with one or more techniques of this disclosure.

FIG. 13 is a flowchart of an example method of graphics processing in accordance with one or more techniques of this disclosure.

FIG. 14 is a flowchart of an example method of graphics processing in accordance with one or more techniques of this disclosure.

### DETAILED DESCRIPTION

In some aspects, some applications may utilize a number of different features. For instance, some applications may utilize an image adjustment feature. These types of applications may receive an image, then go through an image adjustment process, and then output the adjusted image at the end of the process. This adjusted image may be displayed at a display device. In one aspect, the image adjustment process may include a face detection process and/or a face filtering process. Application that perform a face detection process and/or a face filtering process may receive an image including a face, then go through a face filtering process, and then output the filtered image at the end of the process. For example, the face filtering process may include a skin smoothing function, such that the image may smooth the skin of the face. The face filtering process may also include a skin tone adjustment. Further, the face filtering process may include an eye size adjustment. The face filtering process may also include a face size adjustment. After sufficiently filtering the face in the image, the application may output the adjusted image with the filtered face. Some applications may use a single draw call, and then the application may draw multiple primitives (e.g., two triangles) in order to cover a full screen or image. Next, the application may draw the subject of an image (e.g., people in the image) on top of it. When doing so, the application may disable a depth test, so the area or subject of the image (e.g., face) may be overdrawn. Some GPUs may utilize certain functions (e.g., forward pixel kill (FPK)) to remove the overdrawn pixels, but this is not optimal. Other GPUs may utilize a low resolution Z (LRZ) to remove overdrawn pixels. However, when the application disables the depth test, the GPU LRZ cannot help in this case. That is, because the depth test is disabled by the application, the GPU may have no manner in which to reject the overdrawn pixels. By not being able to reject the overdrawn pixels, this results in the GPU unnecessarily rendering these pixels. In turn, this results in an excess amount of power utilized at the GPU and/or an excess amount of work being performed by the GPU. Aspects presented herein may allow for a GPU to be able to reject overdrawn pixels.

Aspects of the present disclosure may include a number of benefits or advantages. For instance, aspects of the present disclosure may be able to reject overdrawn pixels at a GPU. That is, aspects presented herein may reject overdrawn pixels at a GPU when a depth test is disabled. For example, when a depth test is disabled by an application, aspects presented herein may allow a GPU to reject overdrawn pixels. For instance, aspects presented herein may assign a fake depth value and enable a low resolution Z (LRZ) when a depth test is disabled by an application. Indeed, aspects presented herein may utilize temporal information in an LRZ or LRZ buffer in order to reduce workload when depth is disabled. Aspects presented herein may detect that the application does not indicate a depth value for each of the plurality of primitives in the image. Based on this detection, aspects presented herein may determine a depth value for each primitive or triangle in an image. By doing so, aspects presented herein may allow a GPU to reject overdrawn pixels when a depth test is disabled (e.g., disabled by an application). In turn, aspects presented herein may optimize or reduce the amount of power utilized at a GPU when a depth test is disabled. Also, aspects presented herein may optimize or reduce the amount of work being performed by the GPU (e.g., the amount of workloads processed at the GPU) when a depth test is disabled.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended. In some examples, as used herein, the term “graphics workload” may refer to any workload or order associated with graphics processing. In some examples, as used herein, the term “texture fetch” may refer to a memory request, which incurs transactions from a cache (e.g., a texture cache). Each time a warp executes a texture function to read from texture memory, this may be a single texture fetch. Also, texture memory may be read-only device memory, and may be accessed using the device functions described in a texture function. Reading a texture using one of these functions may be called a “texture fetch.” A “render target” may refer to a target block of pixels (buffer) into which rendering will occur. In some aspects, a render target may refer to a buffer where the pixels are drawn (e.g., a video card draws pixels) for a scene that is being rendered in the background. An intermediate render target may refer to a render target that is used in post-processing.

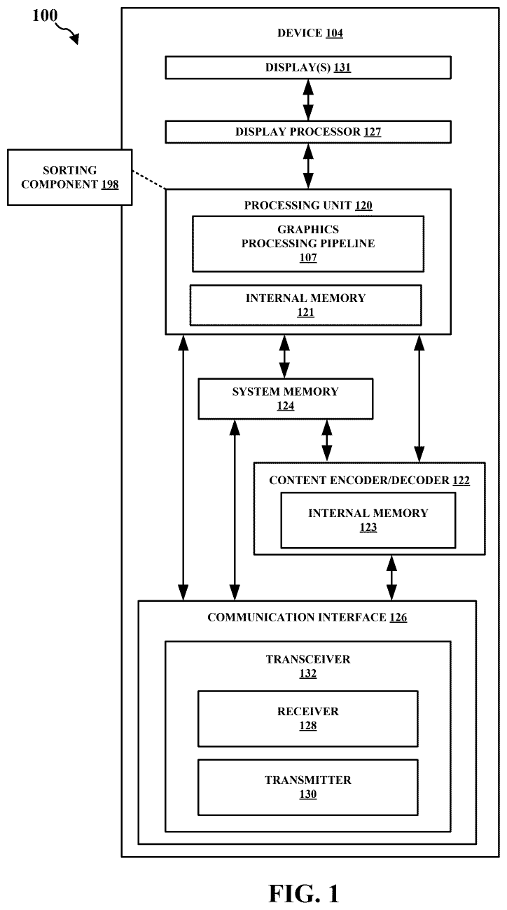

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a sorting component 198 configured to obtain, from an application, an indication of an image including a plurality of primitives. The sorting component 198 may also be configured to configure a primitive mesh based on the plurality of primitives in the image, where the image is a two-dimensional (2D) image or a three-dimensional (3D) image. The sorting component 198 may also be configured to detect that the application does not indicate a depth value for each of the plurality of primitives in the image. The sorting component 198 may also be configured to output an indication that the application does not indicate the depth value for each of the plurality of primitives in the image. The sorting component 198 may also be configured to determine, based on the detection, the depth value for each of the plurality of primitives. The sorting component 198 may also be configured to sort the plurality of primitives in a primitive depth order based on the depth value for each of the plurality of primitives. The sorting component 198 may also be configured to update a depth buffer based on the primitive depth order for the plurality of primitives, where the depth buffer is a low-resolution Z (LRZ) depth buffer, where the depth value is an LRZ depth value. The sorting component 198 may also be configured to output an indication of the primitive depth order for the plurality of primitives. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

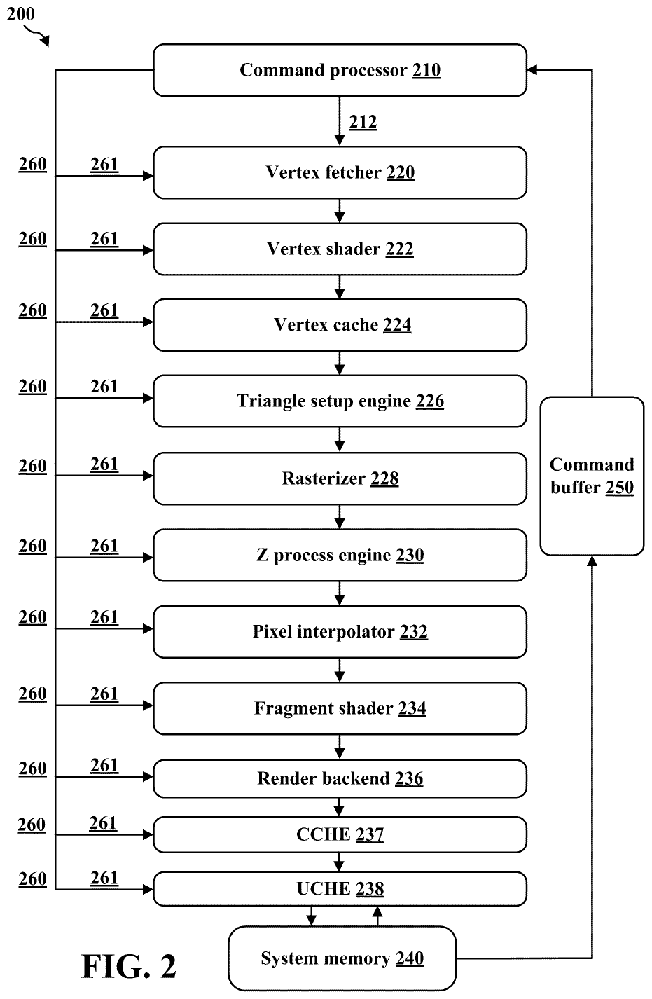

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in double data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

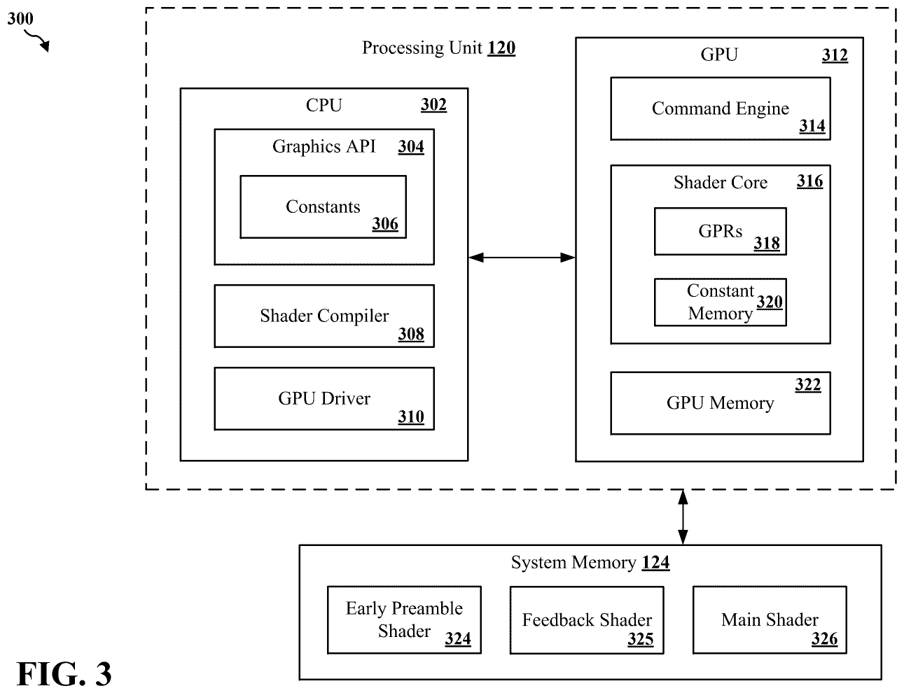

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

GPUs can render images in a variety of different ways. In some instances, GPUs can render an image using rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects, during a binning pass, an image can be divided into different bins or tiles. In some aspects, during the binning pass, a visibility stream can be constructed where visible primitives or draw calls can be identified. In contrast to tiled rendering, direct rendering does not divide the frame into smaller bins or tiles. Rather, in direct rendering, the entire frame is rendered at a single time. Additionally, some types of GPUs can allow for both tiled rendering and direct rendering.

In some aspects, GPUs can apply the drawing or rendering process to different bins or tiles. For instance, a GPU can render to one bin, and perform all the draws for the primitives or pixels in the bin. During the process of rendering to a bin, the render targets can be located in the GMEM. In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory used to drop primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

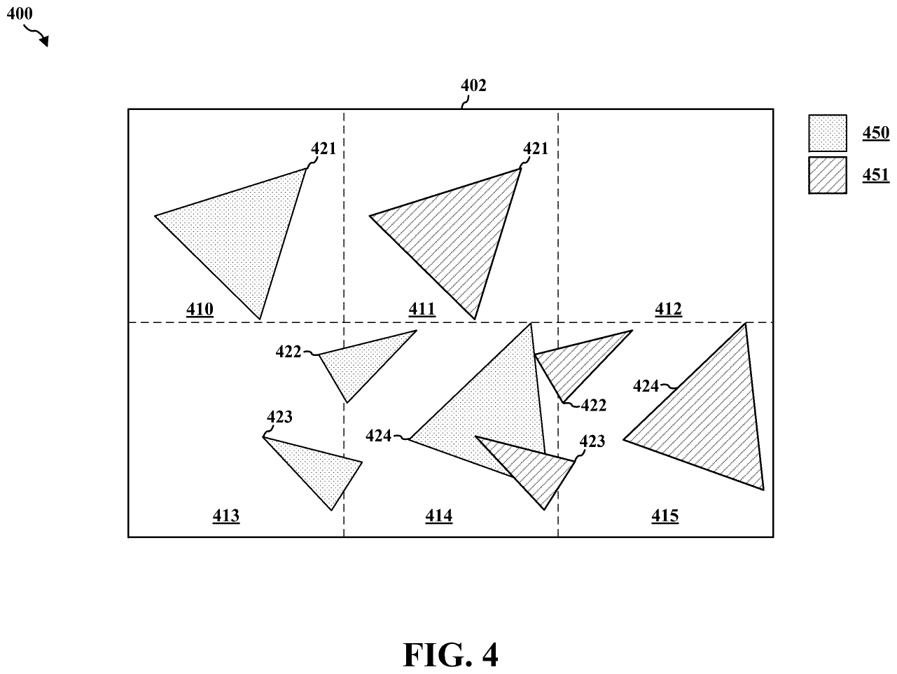

FIG. 4 illustrates image or surface 400, including multiple primitives divided into multiple bins. As shown in FIG. 4, image or surface 400 includes area 402, which includes primitives 421, 422, 423, and 424. The primitives 421, 422, 423, and 424 are divided or placed into different bins, e.g., bins 410, 411, 412, 413, 414, and 415. FIG. 4 illustrates an example of tiled rendering using multiple viewpoints for the primitives 421-424. For instance, primitives 421-424 are in first viewpoint 450 and second viewpoint 451. As such, the GPU processing or rendering the image or surface 400 including area 402 can utilize multiple viewpoints or multi-view rendering.

As indicated herein, GPUs or graphics processor units may use a tiled rendering architecture to reduce power consumption or save memory bandwidth. As further stated above, this rendering method may divide the scene into multiple bins, as well as include a visibility pass that identifies the triangles that are visible in each bin. Thus, in tiled rendering, a full screen may be divided into multiple bins or tiles. The scene may then be rendered multiple times, e.g., one or more times for each bin. In aspects of graphics rendering, some graphics applications may render to a single target, i.e., a render target, one or more times. For instance, in graphics rendering, a frame buffer on a system memory may be updated multiple times. The frame buffer may be a portion of memory or random access memory (RAM), e.g., containing a bitmap or storage, to help store display data for a GPU. The frame buffer may also be a memory buffer containing a complete frame of data. Additionally, the frame buffer may be a logic buffer. In some aspects, updating the frame buffer may be performed in bin or tile rendering, where, as discussed above, a surface is divided into multiple bins or tiles and then each bin or tile may be separately rendered. Further, in tiled rendering, the frame buffer may be partitioned into multiple bins or tiles.

In some aspects of graphics processing, rendering may be performed in multiple locations and/or on multiple devices, e.g., in order to divide the rendering workload between different devices. For example, the rendering may be split between a server and a client device, which may be referred to as “split rendering.” In some instances, split rendering may be a method for bringing content to user devices or head mounted displays (HMDs), where a portion of the graphics processing may be performed outside of the device or HMD, e.g., at a server. Split rendering may be performed for a number of different types of applications, e.g., virtual reality (VR) applications, augmented reality (AR) applications, and/or extended reality (XR) applications. In VR applications, the content displayed at the user device may correspond to man-made or animated content, e.g., content rendered at a server or user device. In AR or XR content, a portion of the content displayed at the user device may correspond to real-world content, e.g., objects in the real world, and a portion of the content may be man-made or animated content. Also, the man-made or animated content and real-world content may be displayed in an optical see-through or a video see-through device, such that the user may view real-world objects and man-made or animated content simultaneously. In some aspects, man-made or animated content may be referred to as augmented content, or vice versa.

In certain types of graphics processing, e.g., augmented reality (AR) applications, virtual reality (VR) applications, or three-dimensional (3D) games, objects may occlude (i.e., obscure, cover, block, or obstruct) other objects from the vantage point of the user device. There may also be different types of occlusions within AR/VR applications or 3D games. For example, augmented content may occlude real-world content, e.g., a rendered object may partially occlude a real object. Also, real-world content may occlude augmented content, e.g., a real object may partially occlude a rendered object. This overlap of real-world content and augmented content, which produces the aforementioned occlusions, is one reason that augmented content and real-world content may blend so seamlessly within AR. This may also result in augmented content and real-world content occlusions being difficult to resolve, such that the edges of augmented and real-world content may incorrectly overlap.

In some aspects, augmented content or augmentations may be rendered over real-world or see-through content. As such, augmentations may occlude whatever object is behind the augmentation from the vantage point of the user device. For example, pixels without an occlusion material, i.e., a red (R), green (G), blue (B) (RGB) value not equal to (0, 0, 0), may be rendered to occlude real-world objects. Accordingly, an augmentation with a certain value (e.g., a non-zero value) may occlude real-world objects behind the augmentation. In video see-through systems, the same effect may be achieved by compositing the augmentation layer to the foreground. As such, augmentations may occlude rendered content or real-world content, or vice versa. As indicated above, when utilizing VR/AR systems or 3D games, capturing occlusions accurately may be a challenge. Moreover, this may be especially true for VR/AR systems or 3D games with latency issues. In some aspects, it may be especially difficult to accurately capture augmented content that is occluding other augmented content, or accurately capture a real-world object that is occluding augmented content. An accurate occlusion of augmented content or real-world content and the occluded augmented content may help a user to obtain a more realistic and immersive VR/AR or 3D game experience.

Some aspects of graphics processing, may utilize occlusion culling, which is a feature that disables the rendering of objects when they are not currently seen by a camera because they are obscured (i.e., occluded) by other objects. For instance, occlusion culling may remove objects in a scene from the camera rendering workload if the objects are entirely obscured by objects closer to the camera. In some aspects, the occlusion culling process may pass through the scene using a virtual camera to build a hierarchy of potentially visible sets of objects. This data may be used by each camera in the graphics processing application to identify which objects are visible or not visible. Occlusion culling may increase rendering performance (e.g., GPU rendering performance) simply by not rendering objects that are outside the viewing area of the camera, or objects that are hidden by other objects closer to the camera. In one instance, the occlusion culling process may be defined as follows: for a camera view in a scene, given a set of occluders (i.e., objects that are occluding other objects) and a set of occludees (i.e., objects that are being occluded by other objects), the visibility of the occludees may be derived or determined based on the relative location of the occluders. For example, if a wall in a scene is closer to the camera than a set of barrels behind the wall, and there are holes in the wall, the occlusion culling process may determine which barrels are visible through the holes in the wall.

Some types of occlusion culling in graphics processing (e.g., occlusion culling for CPUs or GPUs) may include software occlusion culling. For example, in software occlusion culling, for each occluder and each primitive/triangle in a scene, the primitive/triangle may be rasterized to generate an occluder depth map. Also, for each occluder in the scene, the projected axis-aligned bounding box (AABB) area in the occluder depth map may be determined, as well as the nearest depth value of the occludee. Additionally, the occludee's nearest depth value in the projected AABB region may be determined on the occluder depth map. The occludee may be determined to be visible if its nearest depth value is larger than all depth values inside the AABB area. Otherwise, if the occludee's nearest depth value is not larger than all depth values inside the AABB area, the occludee may be determined to be invisible.

Additionally, there are other types of occlusion culling utilized in graphics processing (e.g., occlusion culling in CPUs or GPUs). For instance, there are types of software occlusion culling utilizing CPU single instruction multiple data (SIMD) components. This SIMD-optimized occlusion culling may correspond to an optimized version of an open-source project. This type of occlusion culling may render depth maps (e.g., an occluder depth map) more accurately and faster (e.g., 2-16 times faster) compared to other types of occlusion culling. SIMD-optimized occlusion culling may also be more accurate compared to GPU hardware occlusion culling (HWOC). For example, mobile chip occlusion culling may achieve zero frame latency throughout the rendering process, while GPU hardware occlusion culling may cause latency issues for at least one frame throughout the rendering process. Additionally, SIMD-optimized occlusion culling may result in a smaller draw call amount compared to other types of occlusion culling.

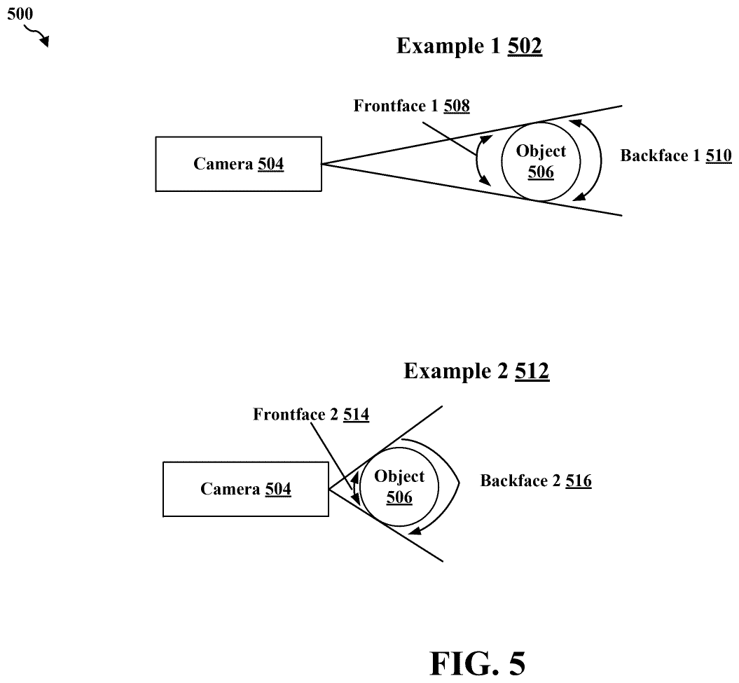

FIG. 5 is a diagram 500 illustrating example aspects of a culling process. A back of a solid, opaque object may be hidden from a direct line of sight from an observer. As such, when a scene is rendered on a display, the observer may not be able to see the back of the solid, opaque object. An apparatus (e.g., a GPU) may cull (i.e., remove) primitives (e.g., triangles) associated with the back of the solid, opaque object in order to reduce an amount of scene geometry that is rendered. The aforementioned culling may be referred to as “culling” or “backface culling.” Reducing the amount of scene geometry that is rendered may reduce an amount of computations performed by the apparatus.

As shown in FIG. 5, in a first example 502, a lens of a camera 504 may face an object 506. The object 506 may be solid and opaque. A portion of the object 506 that is visible to the camera 504 may be referred to as a frontface of the object 506 (referred to now as “a first frontface 508”). A portion of the object 506 that is not visible to the camera 504 may be referred to as a backface of the object 506 (referred to now as “a first backface 510”). In the first example 502, the camera 504 may be located relatively far away from the object 506 and hence the first backface 510 may be around 50% of a surface of the object 506. An apparatus may perform backface culling on primitives associated with the first backface 510 in order to reduce the amount of scene geometry rendered.

As further shown in FIG. 5, in a second example 512, the lens of the camera 504 may face the object 506 as in the first example 502. However, in the second example 512, the object 506 may be located relatively closer to the camera 504 in comparison to a location of the object 506 and the camera 504 in the first example 502. The object 506 may have a second frontface 514 and a second backface 516. As the object 506 is located closer to the lens of the camera 504 compared to the location of the object 506 and the camera 504 in the first example 502, the second backface 516 may be relatively large. For instance, the second backface 516 may be greater than 50% of the surface of the object 506. An apparatus may perform backface culling on primitives associated with the second backface 516 in order to reduce the amount of scene geometry rendered.

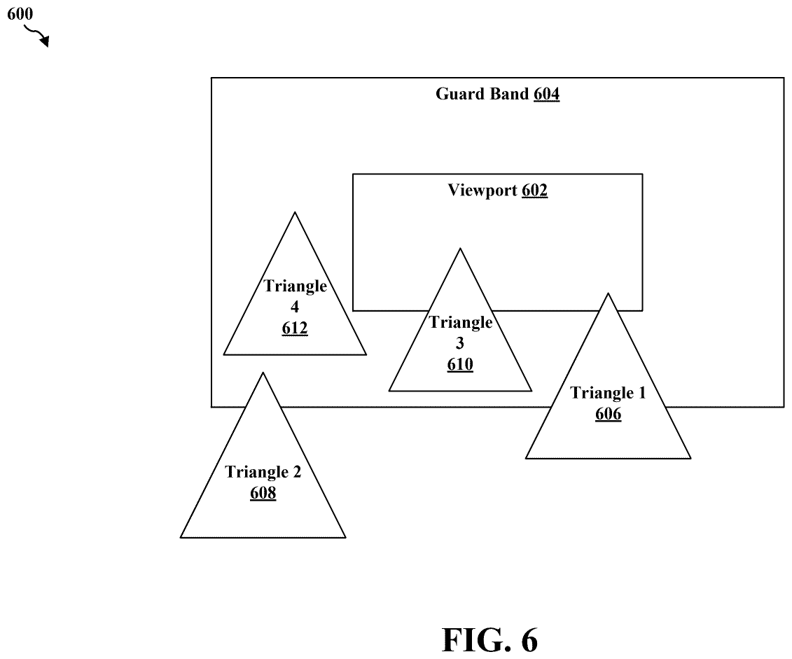

FIG. 6 is a diagram 600 illustrating example aspects of clipping, such as guard band clipping. “Guard band clipping” may refer to a technique used by an apparatus (e.g., a GPU) to reduce an amount of clipping performed. In guard band clipping, a primitive may be clipped if the primitive extends beyond a guard band, where the guard band is associated with a first region that is larger than a second region associated with a viewport and that encompasses the viewport. In an example, the first region associated with the guard band may be orders of magnitude greater than the second region associated with the viewport. In non-guard band clipping, a primitive may be clipped if the primitive extends beyond the viewport. As used herein, the term “clipping” or “clipping operation” may refer to removing a portion of a primitive (e.g., a triangle) from a rendering process. Guard band clipping may enable the apparatus to accept primitives that are partially or completely off-screen.

As shown in FIG. 6, the diagram 600 depicts a viewport 602 and a guard band 604. In an example, the viewport 602 may be associated with a first area and the guard band 604 may be associated with a second area, where the first area is smaller than the second area. The viewport 602 may be located within the guard band 604. In an example, the viewport 602 may be associated with a resolution of 1920 pixels by 1080 pixels. In an example, a first triangle 606 may include a first portion located in the viewport 602, a second portion located outside of the viewport 602 and within the guard band 604, and a third portion located outside of the guard band 604. In an example, the first triangle 606 may be defined by floating point coordinates (described in greater detail below). An apparatus (e.g., a GPU) may clip the second portion and the third portion as the first triangle 606 extends beyond the guard band 604. Alternatively, the apparatus may clip the third portion. After clipping, the first triangle 606 may be represented by fixed point coordinates (described in greater detail below).

As depicted in FIG. 6, in another example, a second triangle 608 may include a first portion that is within the guard band 604 and a second portion that is outside of the guard band 604. The apparatus may remove the second triangle 608 from a rendering process as the second triangle 608 does not intersect the viewport 602. When removed from the rendering process, the second triangle 608 may not have to undergo clipping and hence computational costs may be reduced. Alternatively, the apparatus may clip the second portion of the second triangle 608. In yet another example, a third triangle 610 may include a first portion that is within the viewport 602 and a second portion that is within the guard band 604. As the third triangle 610 does not extend beyond the guard band 604, the apparatus may accept the third triangle 610 and the apparatus may avoid performing clipping on the third triangle 610. In a further example, a fourth triangle 612 may be within the guard band 604 and the fourth triangle 612 may not intersect the viewport 602. The apparatus may remove the fourth triangle 612 from a rendering process as the fourth triangle 612 does not intersect the viewport 602. When removed from the rendering process, the fourth triangle 612 may not have to undergo clipping and hence computational costs may be reduced.

In some aspects, prior to a clipping operation, a graphics processor or GPU may perform primitive assembly, which is the process of grouping of vertices into lines and triangles. Once primitives have been constructed from their individual vertices, they may be clipped against a displayable region (i.e., the window or screen), which may also be a smaller area known as the viewport. The portions of the primitive that are determined to be potentially visible may be sent to a rasterizer or rasterization block. The rasterization block may determine which pixels are covered by the primitive (e.g., a point, line, or triangle) and then sends the list of pixels to a next stage in the pipeline (e.g., fragment shading).

In some aspects of graphics processing, clipping may be performed to selectively enable or disable rendering operations within a certain range of interest (e.g., a viewing frustum). The “view frustum” or “viewing frustum” may be the region of space in a modeled world that may appear on the screen; such as the field of view of a perspective virtual camera system. For example, a box surrounding a viewing plane and virtual space may represent the viewing frustum or view frustum. For instance, rendering may be performed on pixels at the intersection between the defined clipping area and the scene, while pixels/areas outside of the visible area (e.g., viewing frustum) may be removed from the rendering calculation. As the clipping process may reduce the amount of rendering performed (e.g., rendering at a GPU), clipping may help to improve rendering performance (e.g., at a GPU). Further, a clipping process that is well-defined may allow the rendering component (e.g., a GPU) to reduce processing time and energy by skipping rendering calculations that fall outside of the visible area (e.g., viewing frustum). In some instances, clipping may occur in a Cartesian space (i.e., with Cartesian coordinates).

Additionally, in some aspects of graphics processing (e.g., three-dimensional (3D) graphics), clipping and culling may be used to describe many related features. For example, “clipping” may refer to operations in the plane that work with certain shapes (e.g., rectangular shapes), while “culling” may refer to more general methods of selectively processing elements within a scene model. In some instances, elements of a scene model may include certain geometric primitives (e.g., points/nodes, line segments/edges, polygons/faces). A “primitive” may refer to a graphics object that is utilized for the creation or construction of complex images, such as a shape (e.g., a triangle). In some types of scene models, individual elements can be deactivated (truncated) for reasons of visibility within the viewport or viewing section (e.g., backface culling, occlusion culling, depth clipping or Z-clipping, etc.). There may be different types of algorithms performed at a GPU in order to detect and perform such clipping operations. Further, in some aspects, clipping may be performed by determining which side of each of a plane (e.g., a plane in the viewing frustum) the vertices of each primitive lie. For example, if a primitive's vertices are all on the “outside” of any one plane (e.g., a plane in the viewing frustum), then the entire primitive may be discarded. If all of primitive's vertices are all on the “inside” of all the planes (and thus entirely inside the viewing frustum or view volume), then the primitive may be passed through unaltered. Primitives that are partially visible (i.e., they cross one of the planes in the viewing frustum) may be handled on an individual basis according to the functionality of the GPU.

In depth clipping or Z-clipping (or Z clipping), the “Z” direction may refer to the depth axis in the coordinate system, which is centered on a viewport origin within the viewing frustum. For instance, the “Z” direction may be used interchangeably with “depth” and may correspond to the distance “into the virtual screen” from the viewport origin. Also, in this coordinate system, “X” and “Y” may refer to a conventional Cartesian coordinate system located on the user's screen or the viewport. In some instances, the viewport may also be defined by the geometry of the field of view (FoV). Additionally, Z-clipping or depth clipping may refer to techniques for selectively rendering certain scene objects based on their depth (or Z-axis) relative to the screen. Further, a near clipping depth and a far clipping depth may be specified relative to the screen, such that the portions of objects between these two specified depths may be displayed.

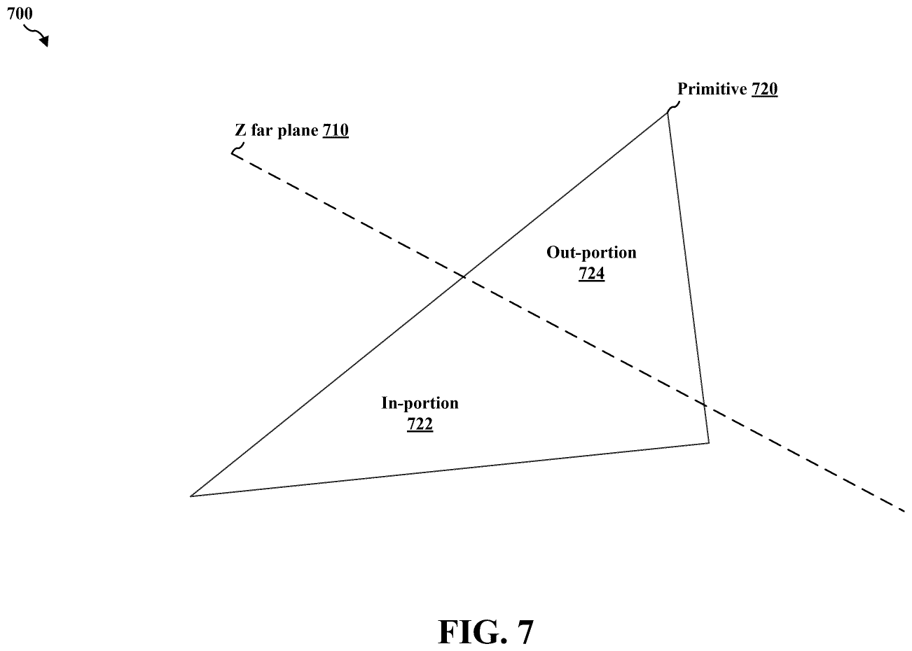

FIG. 7 is a diagram 700 illustrating an example primitive clipping operation. More specifically, diagram 700 depicts a clipping operation performed on a primitive in a Z-direction (i.e., Z clipping). As shown in FIG. 7, diagram 700 includes Z far plane 710 and primitive 720 including in-portion 722 and out-portion 724. FIG. 7 depicts that primitive 720 is divided in the Z direction by Z far plane 710, which produces in-portion 722 (i.e., the portion of primitive 720 that is within the viewing frustum) and out-portion 724 (i.e., the portion of primitive 720 that is outside of the viewing frustum). For instance, in-portion 722 depicts the primitive portion and vertices of primitive 720 that are within the Z far plane 710 (e.g., a plane in a Z direction in the viewing frustum). Likewise, out-portion 724 depicts the primitive portion and vertices of primitive 720 that are outside of the Z far plane 710 (e.g., a plane in a Z direction in the viewing frustum). As indicated herein, if a primitive's vertices (e.g., vertices of primitive 720) are all outside of any one plane (e.g., Z far plane 710), then the entire primitive may be discarded. Further, if all of primitive's vertices (e.g., vertices of primitive 720) are within all the planes (e.g., Z far plane 710 thus entirely inside the viewing frustum or view volume), then the primitive may be passed through unaltered. As shown in FIG. 7, primitives that are partially visible (i.e., they are bisected by Z far plane), such as primitive 720, may be handled on an individual basis. For example, the vertices or pixels corresponding to in-portion 722 of primitive 720 may be retained, while the vertices or pixels corresponding to out-portion 724 of primitive 720 may be discarded.

In some aspects, some applications may utilize a number of different features. For instance, some applications may utilize an image adjustment feature. These types of applications may receive an image, then go through an image adjustment process, and then output the adjusted image at the end of the process. This adjusted image may be displayed at a display device. In one aspect, the image adjustment process may include a face detection process and/or a face filtering process. Application that perform a face detection process and/or a face filtering process may receive an image including a face, then go through a face filtering process, and then output the filtered image at the end of the process. For example, the face filtering process may include a skin smoothing function, such that the image may smooth the skin of the face. The face filtering process may also include a skin tone adjustment. Further, the face filtering process may include an eye size adjustment. The face filtering process may also include a face size adjustment. After sufficiently filtering the face in the image, the application may output the adjusted image with the filtered face.

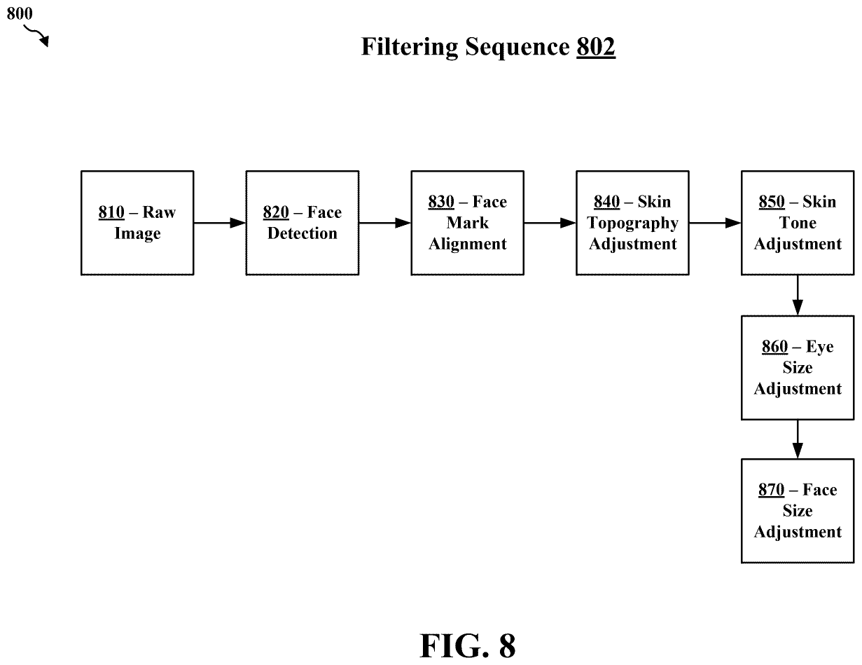

FIG. 8 illustrates diagram 800 including one example of a filtering sequence. More specifically, diagram 800 depicts an example application that may perform a filtering sequence 802 including a face filtering process. As shown in FIG. 8, at 810, the application may obtain a raw image including a face. At 820, the application may perform a face detection process. For example, the application may detect a face within the raw image. At 830, the application may perform a face mark alignment process. For example, the application may perform a face alignment (e.g., align the face within the image) and/or a Delaunay triangulation (e.g., a Delaunay triangulation or Delone triangulation of a set of points in a plane subdivides their convex hull into triangles whose circumcircles do not contain any of the points). At 840, the application may perform a skin topography adjustment process. For example, the application may perform a skin smoothing process on the face in the image. For instance, the application may receive a filtering input (p) and/or a filtering output (q). At 850, the application may perform a skin tone adjustment process. For example, the application may adjust the skin tone on the face in the image to be lighter or darker. At 860, the application may perform an eye size adjustment process. For example, the application may adjust the size of the eyes on the face in the image (e.g., enlarge the size of the eyes or reduce the size of the eyes). At 870, the application may perform a face size adjustment process. For example, the application may adjust the size of the face in the image (e.g., reduce the size of the face or increase the size of the face). Once the face filtering process is done, the application may output the final image including the filtered face.

As shown in FIG. 8, some applications may use a single draw call (e.g., a draw call with GL_TRIANGLE), and then the application may draw multiple primitives (e.g., two triangles) in order to cover a full screen or image. Next, the application may draw the subject of an image (e.g., people in the image) on top of it. When doing so, the application may disable a depth test, so the area or subject of the image (e.g., face) may be overdrawn. Some GPUs may utilize certain functions (e.g., forward pixel kill (FPK)) to remove the overdrawn pixels, but this is not optimal. Other GPUs may utilize a low resolution Z (LRZ) to remove overdrawn pixels. However, when the application disables the depth test, the GPU LRZ cannot help in this case. That is, because the depth test is disabled by the application, the GPU may have no manner in which to reject the overdrawn pixels. By not being able to reject the overdrawn pixels, this results in the GPU unnecessarily rendering these pixels. In turn, this results in an excess amount of power utilized at the GPU and/or an excess amount of work being performed by the GPU. Based on the above, it may be beneficial for a GPU to be able to reject overdrawn pixels. That is, it may be beneficial for a GPU to reject overdrawn pixels when a depth test is disabled (e.g., disabled by an application). In turn, it may be beneficial to optimize the amount of power utilized at the GPU when a depth test is disabled. Also, it may be beneficial to optimize the amount of work being performed by the GPU when a depth test is disabled.

Aspects of the present disclosure may be able to reject overdrawn pixels at a GPU. That is, aspects presented herein may reject overdrawn pixels at a GPU when a depth test is disabled. For example, when a depth test is disabled by an application, aspects presented herein may allow a GPU to reject overdrawn pixels. For instance, aspects presented herein may assign a fake depth value and enable a low resolution Z (LRZ) when a depth test is disabled by an application. Indeed, aspects presented herein may utilize temporal information in an LRZ or LRZ buffer in order to reduce workload when depth is disabled. Aspects presented herein may detect that the application does not indicate a depth value for each of the plurality of primitives in the image. Based on this detection, aspects presented herein may determine a depth value for each primitive or triangle in an image. By doing so, aspects presented herein may allow a GPU to reject overdrawn pixels when a depth test is disabled (e.g., disabled by an application). In turn, aspects presented herein may optimize or reduce the amount of power utilized at a GPU when a depth test is disabled. Also, aspects presented herein may optimize or reduce the amount of work being performed by the GPU (e.g., the amount of workloads processed at the GPU) when a depth test is disabled.

Aspects presented herein may perform a number of adjustments in order to resolve the aforementioned overdrawn pixel issue. That is, aspects presented herein may allow a GPU to manually perform some adjustments to the application. For example, aspects presented herein may perform a local experiment showing an LRZ can reject a certain amount of workload (e.g., 43% of fragment shader (FS) workload) when enabling LRZ in binning (e.g., for face enlarging/face slimming surfaces). This may result in a decrease in frame processing time (e.g., a 3.1% decrease in frame processing time).

In some instances, aspects presented herein may opt for certain modes at a GPU in order to resolve the aforementioned overdrawn pixel issues. For example, in order to resolve the aforementioned overdrawn pixel issues, aspects presented herein may opt for a binning mode at a GPU. Aspects presented herein may also turn on an LRZ (e.g., an LRZ buffer) in order to reduce the aforementioned overdrawn pixel issues. In some aspects, in order to resolve the aforementioned overdrawn pixel issues, aspects presented herein may assign a fake depth value and enable LRZ when a depth test is disabled by an application. For instance, when a depth test is disabled by an application, aspects presented herein may allow a GPU to assign a fake depth value to certain primitives and/or enable an LRZ or LRZ buffer.

Aspects presented herein may allow for a number of solutions to resolve the aforementioned overdrawn pixel issues. For instance, aspects presented herein may utilize a software solution, such as via a compiler at a GPU or a driver at a GPU. In general, when a compiler or a driver detects such a case (e.g., when a depth test is disabled by an application), aspects presented herein may allow a GPU to append or add a depth value for each vertex (or a primitive if GL_TRIANGLE). The depth value of a primitive may be determined based on a primitive identifier (ID). For example, a depth value for each primitive may be equal to: 1−(vertex ID/divisor factor) (e.g., gl_Position. Z=1−gl_VertexID/DivisorFactor). The divisor factor (DivisorFactor) may be a variable that is configurable (e.g., 2\hat{ }16 or 2\hat{ }15 . Additionally, the depth value of a primitive may be determined based on a primitive ID. For example, a depth value for each primitive may be equal to: 1−(primitive ID/divisor factor) (e.g., If GL_TRIANGLE, then gl_Position. Z=1−gl_PrimitiveID/DivisorFactor). Indeed, the compiler or drive at a GPU may assign a fake depth value (e.g., gl_Position. Z=1−PrimitiveID/DivisorFactor). In some instances, the global primitive ID may need consider multiple draws and multiple instances of primitives. Also, the driver may turn on the LRZ or LRZ buffer for a depth update/test. In some aspects, the LRZ bit storage may have certain limit, such as if a primitive amount exceeds a certain range. For example, if a primitive amount is more than certain range, aspects presented herein may need to perform a clamping process or a clipping process (i.e., clamping or clipping is a process that limits a value to a range between a minimum value and a maximum value).

Aspects presented herein may also utilize a hardware solution to resolve the aforementioned overdrawn pixel issues, such as hardware at a GPU. Aspects presented herein may utilize temporal information in an LRZ or an LRZ buffer in order to reduce workload when a depth test is disabled. When it is determined that a depth test is disabled, the temporal information may be introduced as the LRZ depth value. The subsequent primitives may then be taken at a certain area of the image (e.g., closer to the eyes of a face). One idea is for an LRZ to utilize the primitive count or primitive ID (prim_ID) to represent the LRZ value. Since subsequent primitives may have a larger primitive ID (prim_ID) value, the LRZ may naturally drop the previous primitives. Also, the binning and rendering pass may have the same primitive ID (prim_ID) for the same primitives. During binning, the LRZ buffer may be created using the primitive ID (prim_ID). This LRZ buffer may be utilized during rendering to remove or kill the overdrawn primitives. Further, in some aspects, the LRZ bit storage may have a certain limit, such as if a primitive amount more than certain range, then the primitive ID based solution may need to perform a clamping process or a clipping process.

Additionally, aspects presented herein may utilize additional hardware solutions to resolve the aforementioned overdrawn pixel issues, such as hardware at a GPU. In these additional hardware solutions, aspects presented herein may utilize temporal information in an LRZ or an LRZ buffer in order to reduce workload when a depth test is disabled. Aspects presented herein may also utilize a counter-based LRZ solution. For instance, aspects presented herein may allow a GPU or LRZ to utilize a counter ID to represent an LRZ value. In a binning stage, the counter ID may be incremented when a bin or tile is touched by a primitive. In some aspects, the LRZ test may always pass in the binning stage. Also, the LRZ value may be incremented when a bin or tile is touched by a primitive. When a primitive is partially covered, the LRZ merge algorithm may work as normal. In a rendering stage, the counter ID will be decremented when touched by a primitive. Also, a primitive may be rejected at the rendering stage if the counter value is non-zero. And a primitive may be accepted at the rendering stage if the counter value is zero. Moreover, in a rendering stage, the LRZ test may fail when the LRZ value is non-zero, and at the same time decrease the LRZ buffer value.

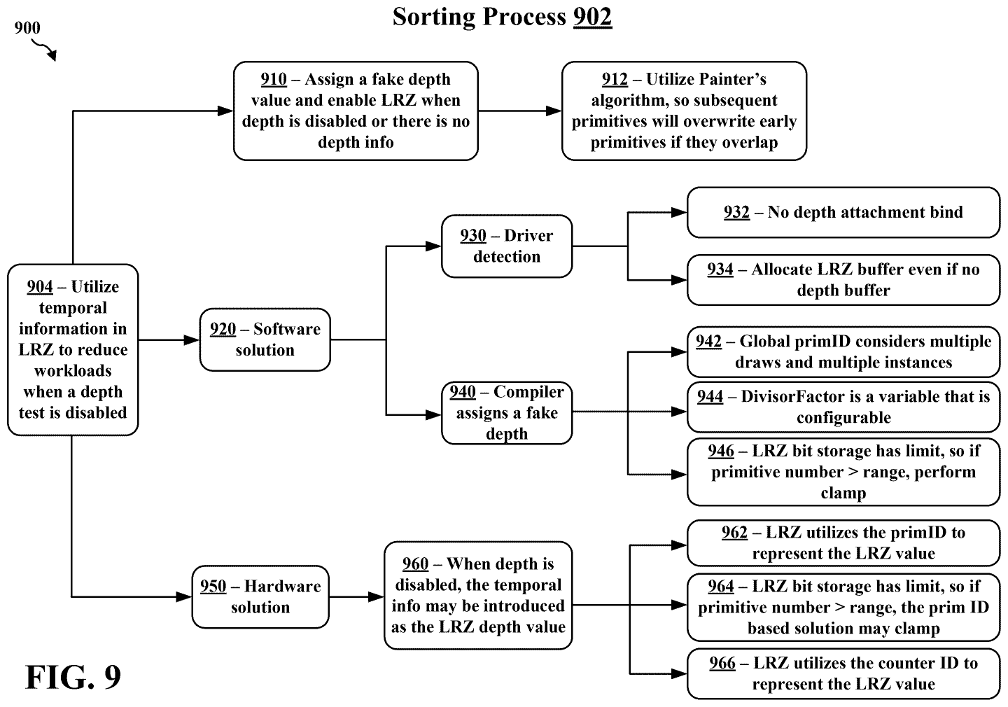

FIG. 9 illustrates diagram 900 including one example of a sorting process. More specifically, diagram 900 depicts sorting process 902 for when a depth test is disabled. As shown in FIG. 9, at 904, a GPU may utilize temporal information in an LRZ or LRZ buffer to reduce workloads when a depth test is disabled by an application. At 910, a GPU may assign a fake depth value and enable an LRZ when a depth test is disabled or there is no depth information. At 912, the GPU may utilize a painter's algorithm, so subsequent primitives will overwrite early primitives if they overlap. The painter's algorithm (i.e., depth-sort algorithm and priority fill) is an algorithm for visible surface determination in computer graphics that works on a polygon-by-polygon basis rather than a pixel-by-pixel, row by row, or area by area basis of other hidden surface removal algorithms. The painter's algorithm creates images by sorting the polygons within the image by their depth and placing each polygon in order from the farthest to the closest object. At 920, the GPU may perform a software solution. At 930, the GPU may utilize driver detection. For instance, at 932, the GPU may determine that no depth attachment bind is the easiest case to detect, and will cover most video applications and image post-process surface (popular in gaming applications). At 934, the GPU may allocate an LRZ buffer even if there is no depth buffer. At 940, the GPU may utilize a compiler to assign a fake depth value (e.g., gl_Position. Z=1−PrimitiveID/DivisorFactor). At 942, the GPU may utilize a global primitive ID to consider multiple draws and multiple instances. At 944, the GPU may utilize a divisor factor, which is a variable that is configurable (e.g., 2\hat{ }16 or 2\hat{ }15). At 946, if the GPU determines that the LRZ bit storage has a limit, so if a primitive number>range, then the GPU may perform clamping or clipping.

As shown in FIG. 9, at 950, the GPU may perform a hardware solution. For instance, at 960, when depth is disabled, the temporal information may be introduced as the LRZ depth value. For example, the subsequent primitives can be taken at a certain area of the image (e.g., closer to the eyes of the face). At 962, the LRZ may utilize the primitive ID to represent the LRZ value. Since subsequent primitives may have a larger primitive ID value, the LRZ may naturally drop the previous primitives. Also, binning and rendering pass may have the same prim_ID for the same primitives. During binning, the LRZ buffer may be created using the prim_ID. This LRZ buffer may be utilized during rendering to kill the overlapping primitives. At 964, if the GPU determines the LRZ bit storage has a limit, so if a primitive number>range, the primitive ID-based solution may clamp or clip. At 966, the LRZ utilizes the counter ID to represent the LRZ value. For instance, once a tile is touched by a primitive, the counter ID may be incremented in the binning stage. In the rendering stage, the counter ID may be decremented when touched by a primitive, and a primitive may be rejected at the rendering stage if the counter value is non-zero. And a primitive may be accepted at the rendering stage if the counter value is zero.

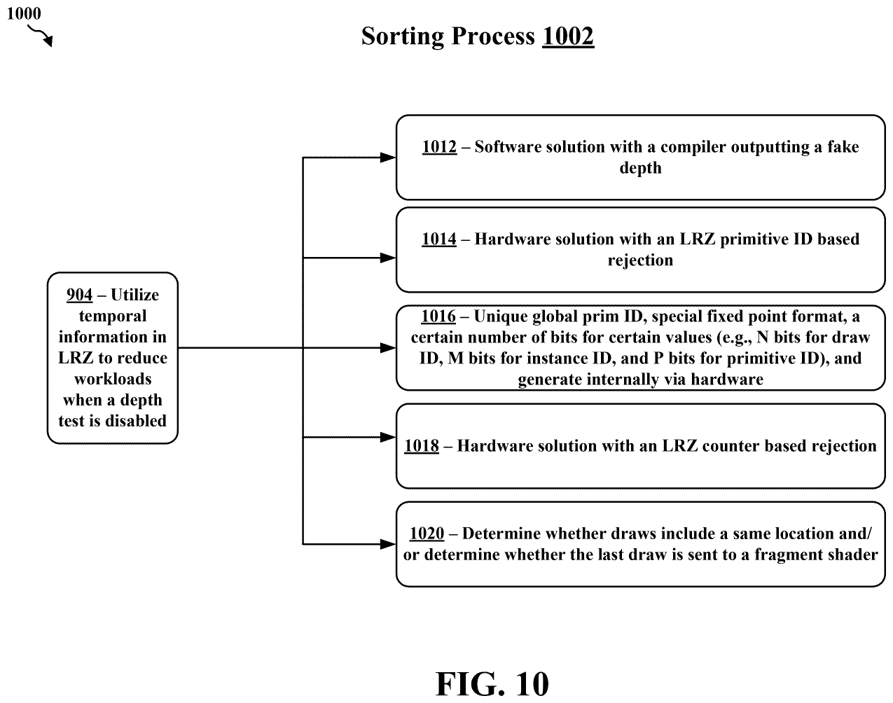

FIG. 10 illustrates diagram 1000 including one example of a sorting process. More specifically, diagram 1000 depicts sorting process 1002 for when a depth test is disabled. As shown in FIG. 10, similar to FIG. 9, at 904, a GPU may utilize temporal information in an LRZ or LRZ buffer to reduce workloads when a depth test is disabled by an application. At 1012, a GPU may utilize a software solution with a compiler outputting a fake depth. At 1014, a GPU may utilize a hardware solution with an LRZ primitive ID based rejection. At 1016, a GPU may utilize a unique global primitive ID, a special fixed point format, a certain number of bits for certain values (e.g., N bits for a draw ID, M bits for an instance ID, and P bits for a primitive ID), and generate this internally via hardware. At 1018, a GPU may utilize a hardware solution with an LRZ counter based rejection. At 1020, a GPU may determine whether draws include a same location and/or determine whether a last draw is sent to a fragment shader.

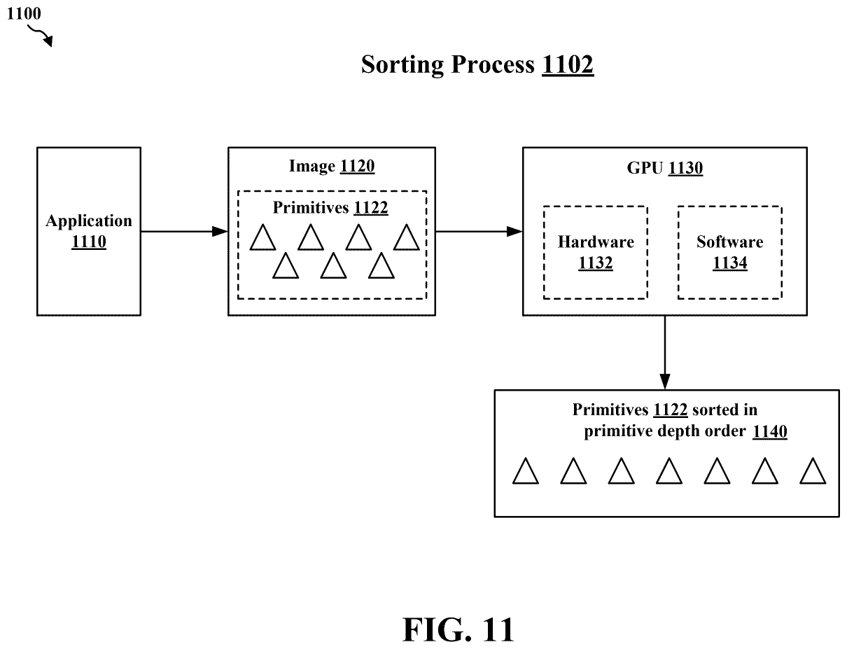

FIG. 11 illustrates diagram 1100 including one example of a sorting process. More specifically, diagram 1100 depicts sorting process 1102 at GPU 1130. As shown in FIG. 11, application 1110 may send GPU 1130 an indication of an image 1120 including a plurality of primitives 1122. For instance, GPU 1130 may obtain, from an application, an indication of image 1120 including a plurality of primitives 1122. GPU 1130 may detect that the application 1110 does not indicate a depth value for each of the plurality of primitives 1122 in the image 1120. GPU 1130 may also determine, based on the detection, the depth value for each of the plurality of primitives 1122. In some aspects, determining the depth value for each of the plurality of primitives 1122 may comprise determining the depth value for each of the plurality of primitives 1122 via hardware 1132 at GPU 1130. Also, determining the depth value for each of the plurality of primitives 1122 may comprise determining the depth value for each of the plurality of primitives 1122 via software 1134 at GPU 1130, a compiler at GPU 1130, or a driver at GPU 1130. Additionally, GPU 1130 may sort the plurality of primitives 1122 in a primitive depth order 1140 based on the depth value for each of the plurality of primitives 1122. Moreover, GPU 1130 may output an indication of the primitive depth order 1140 for the plurality of primitives 1122.

Aspects of the present disclosure may include a number of benefits or advantages. For instance, aspects of the present disclosure may be able to reject overdrawn pixels at a GPU. That is, aspects presented herein may reject overdrawn pixels at a GPU when a depth test is disabled. For example, when a depth test is disabled by an application, aspects presented herein may allow a GPU to reject overdrawn pixels. For instance, aspects presented herein may assign a fake depth value and enable a low resolution Z (LRZ) when a depth test is disabled by an application. Also, aspects presented herein may utilize any other type of Z test or depth test, such as a fine resolution Z depth test. For example, aspects presented herein may assign a fake depth value and enable a fine resolution Z when a depth test is disabled by an application. Additionally, aspects presented herein may utilize different types of depth blocks, such as a low-resolution Z (LRZ) depth block and/or a fine resolution Z depth block. Further, the depth value may be an LRZ depth value and/or a fine resolution Z depth value. Indeed, aspects presented herein may utilize temporal information in an LRZ or LRZ buffer in order to reduce workload when depth is disabled. Aspects presented herein may detect that the application does not indicate a depth value for each of the plurality of primitives in the image. Based on this detection, aspects presented herein may determine a depth value for each primitive or triangle in an image. By doing so, aspects presented herein may allow a GPU to reject overdrawn pixels when a depth test is disabled (e.g., disabled by an application). In turn, aspects presented herein may optimize or reduce the amount of power utilized at a GPU when a depth test is disabled. Also, aspects presented herein may optimize or reduce the amount of work being performed by the GPU (e.g., the amount of workloads processed at the GPU) when a depth test is disabled.

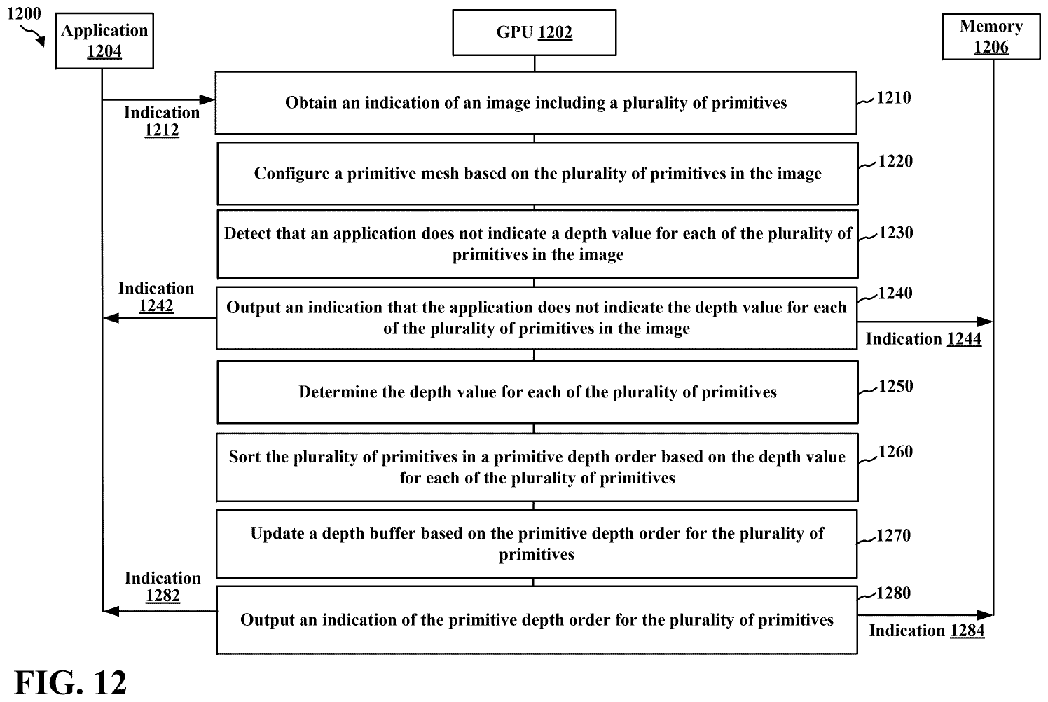

FIG. 12 is a communication flow diagram 1200 of graphics processing in accordance with one or more techniques of this disclosure. As shown in FIG. 12, diagram 1200 includes example communications between GPU 1202 (e.g., a GPU, a GPU component, another graphics processor, a CPU, a CPU component, or another central processor), application 1204 (e.g., an application, a game, a CPU, a CPU component, or another central processor), and memory 1206 (e.g., a memory, a cache, a system memory, a graphics memory, a memory or cache at a CPU, or a memory or cache at a GPU), in accordance with one or more techniques of this disclosure.

At 1210, GPU 1202 may obtain, from an application, an indication of an image including a plurality of primitives. For example, GPU 1202 may receive indication 1212 from application 1204 or a GPU/CPU.

At 1220, GPU 1202 may configure a primitive mesh based on the plurality of primitives in the image, where the image is a two-dimensional (2D) image or a three-dimensional (3D) image.

At 1230, GPU 1202 may detect that the application does not indicate a depth value for each of the plurality of primitives in the image. In some aspects, detecting that the application does not indicate the depth value for each of the plurality of primitives may comprise: detecting, via a graphics processing unit (GPU) driver at a GPU, that the application does not indicate the depth value for each of the plurality of primitives, and the depth value for each of the plurality of primitives may be configured to be disabled at the application.

At 1240, GPU 1202 may output an indication that the application does not indicate the depth value for each of the plurality of primitives in the image. For example, GPU 1202 may transmit indication 1242 to application 1204 or a GPU/CPU. Also, for example, GPU 1202 may store indication 1244 in memory 1206.

At 1250, GPU 1202 may determine, based on the detection, the depth value for each of the plurality of primitives. In some aspects, determining the depth value for each of the plurality of primitives may comprise: determining the depth value for each of the plurality of primitives via hardware at a graphics processing unit (GPU). Also, determining the depth value for each of the plurality of primitives may comprise: determining the depth value for each of the plurality of primitives based on a primitive identifier (ID) for each of the plurality of primitives. Further, determining the depth value for each of the plurality of primitive may comprise: obtaining, from a depth block at the GPU, the primitive ID for each of the plurality of primitives; and assigning the primitive ID for each of the plurality of primitives as the depth value for each of the plurality of primitives. In some aspects, the assignment of the primitive ID may be based on a sequence order of the plurality of primitives, where each primitive in the plurality of primitives that is a current primitive in the sequence order for a corresponding depth value may be assigned the corresponding depth value, where the depth block may be a low-resolution Z (LRZ) depth block, and where the depth value may be an LRZ depth value.

In some aspects, determining the depth value for each of the plurality of primitives may comprise: determining the depth value for each of the plurality of primitives based on a counter identifier (ID) for each of the plurality of primitives. Also, determining the depth value for each of the plurality of primitives may comprise: associating a counter ID for each tile that is touched by each of the plurality of primitives; incrementing a value of the counter ID based on a sequence order of the plurality of primitives; and updating a depth buffer based on the incremented value of the counter ID for each of the plurality of primitives. Further, determining the depth value for each of the plurality of primitives further may comprise: decrementing the value of the counter ID for each tile that is touched by each of the plurality of primitives; rejecting, based on the value of the counter ID being non-zero, a corresponding primitive of the plurality of primitives for each tile; and accepting, based on the value of the counter ID being equal to zero, the corresponding primitive of the plurality of primitives for each tile.

Additionally, in some aspects, determining the depth value for each of the plurality of primitives may comprise: determining the depth value for each of the plurality of primitives via a compiler at a graphics processing unit (GPU) or software at the GPU. Also, determining the depth value for each of the plurality of primitives may comprise: determining the depth value for each of the plurality of primitives based on a primitive identifier (ID) for each of the plurality of primitives. In some instances, the depth value for each of the plurality of primitives may be equal to: [1−(primitive ID/divisor factor)]. Also, determining the depth value for each of the plurality of primitives may comprise: determining the depth value for each of the plurality of primitives based on a vertex identifier (ID) for each vertex of each of the plurality of primitives. The depth value for each of the plurality of primitives may be equal to: [1−(vertex ID/divisor factor)].

At 1260, GPU 1202 may sort the plurality of primitives in a primitive depth order based on the depth value for each of the plurality of primitives.

At 1270, GPU 1202 may update a depth buffer based on the primitive depth order for the plurality of primitives, where the depth buffer is a low-resolution Z (LRZ) depth buffer, where the depth value is an LRZ depth value.

At 1280, GPU 1202 may output an indication of the primitive depth order for the plurality of primitives. In some aspects, outputting the indication of the primitive depth order for the plurality of primitives may comprise: transmitting the indication of the primitive depth order for the plurality of primitives. For example, GPU 1202 may transmit indication 1282 to application 1204 or a GPU/CPU. Also, outputting the indication of the primitive depth order for the plurality of primitives may comprise: storing the indication of the primitive depth order for the plurality of primitives. For example, GPU 1202 may store indication 1284 in memory 1206.

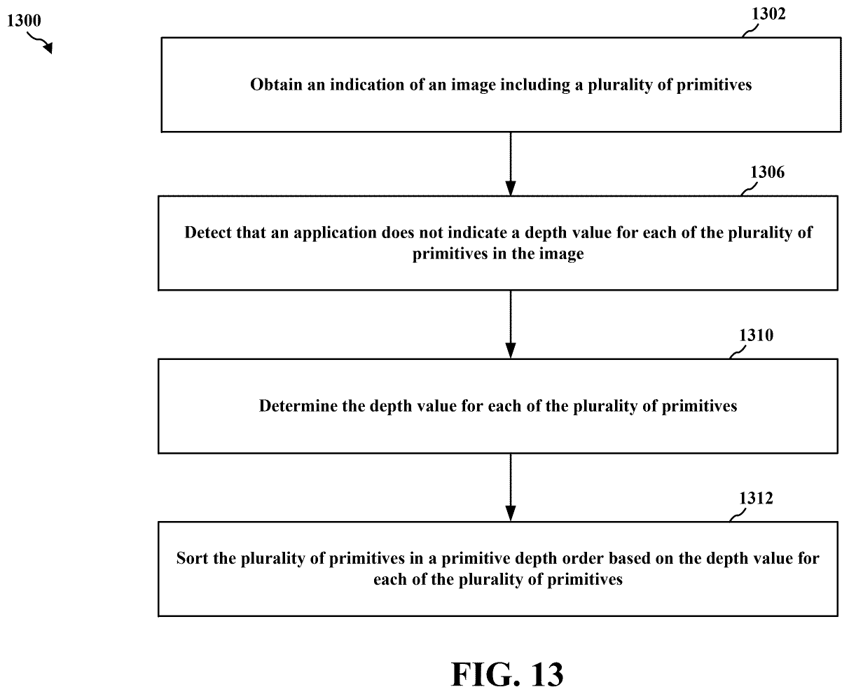

FIG. 13 is a flowchart 1300 of an example method of graphics processing in accordance with one or more techniques of this disclosure. The method may be performed by a GPU (e.g., a GPU, a GPU component, another graphics processor, a CPU, a CPU component, or another central processor), a CPU (e.g., a CPU, a cache at a CPU, a CPU component, another central processor, a GPU, a GPU component, or another graphics processor), an application, a game, a display driver integrated circuit (DDIC), an apparatus for graphics processing, a wireless communication device, and/or any apparatus that may perform graphics processing as used in connection with the examples of FIGS. 1-12.

At 1302, the GPU may obtain, from an application, an indication of an image including a plurality of primitives, as described in connection with the examples in FIGS. 1-12. For example, as described in 1210 of FIG. 12, GPU 1202 may obtain, from an application, an indication of an image including a plurality of primitives. Further, step 1302 may be performed by processing unit 120 in FIG. 1. For example, GPU 1202 may receive indication 1212 from application 1204 or a GPU/CPU.

At 1306, the GPU may detect that the application does not indicate a depth value for each of the plurality of primitives in the image, as described in connection with the examples in FIGS. 1-12. For example, as described in 1230 of FIG. 12, GPU 1202 may detect that the application does not indicate a depth value for each of the plurality of primitives in the image. Further, step 1306 may be performed by processing unit 120 in FIG. 1. In some aspects, detecting that the application does not indicate the depth value for each of the plurality of primitives may comprise: detecting, via a graphics processing unit (GPU) driver at a GPU, that the application does not indicate the depth value for each of the plurality of primitives, and the depth value for each of the plurality of primitives may be configured to be disabled at the application.

At 1310, the GPU may determine, based on the detection, the depth value for each of the plurality of primitives, as described in connection with the examples in FIGS. 1-12. For example, as described in 1250 of FIG. 12, GPU 1202 may determine, based on the detection, the depth value for each of the plurality of primitives. Further, step 1310 may be performed by processing unit 120 in FIG. 1. In some aspects, determining the depth value for each of the plurality of primitives may comprise: determining the depth value for each of the plurality of primitives via hardware at a graphics processing unit (GPU). Also, determining the depth value for each of the plurality of primitives may comprise: determining the depth value for each of the plurality of primitives based on a primitive identifier (ID) for each of the plurality of primitives. Further, determining the depth value for each of the plurality of primitive may comprise: obtaining, from a depth block at the GPU, the primitive ID for each of the plurality of primitives; and assigning the primitive ID for each of the plurality of primitives as the depth value for each of the plurality of primitives. In some aspects, the assignment of the primitive ID may be based on a sequence order of the plurality of primitives, where each primitive in the plurality of primitives that is a current primitive in the sequence order for a corresponding depth value may be assigned the corresponding depth value, where the depth block may be a low-resolution Z (LRZ) depth block, and where the depth value may be an LRZ depth value.

In some aspects, determining the depth value for each of the plurality of primitives may comprise: determining the depth value for each of the plurality of primitives based on a counter identifier (ID) for each of the plurality of primitives. Also, determining the depth value for each of the plurality of primitives may comprise: associating a counter ID for each tile that is touched by each of the plurality of primitives; incrementing a value of the counter ID based on a sequence order of the plurality of primitives; and updating a depth buffer based on the incremented value of the counter ID for each of the plurality of primitives. Further, determining the depth value for each of the plurality of primitives further may comprise: decrementing the value of the counter ID for each tile that is touched by each of the plurality of primitives; rejecting, based on the value of the counter ID being non-zero, a corresponding primitive of the plurality of primitives for each tile; and accepting, based on the value of the counter ID being equal to zero, the corresponding primitive of the plurality of primitives for each tile.

Additionally, in some aspects, determining the depth value for each of the plurality of primitives may comprise: determining the depth value for each of the plurality of primitives via a compiler at a graphics processing unit (GPU) or software at the GPU. Also, determining the depth value for each of the plurality of primitives may comprise: determining the depth value for each of the plurality of primitives based on a primitive identifier (ID) for each of the plurality of primitives. In some instances, the depth value for each of the plurality of primitives may be equal to: [1−(primitive ID/divisor factor)]. Also, determining the depth value for each of the plurality of primitives may comprise: determining the depth value for each of the plurality of primitives based on a vertex identifier (ID) for each vertex of each of the plurality of primitives. The depth value for each of the plurality of primitives may be equal to: [1−(vertex ID/divisor factor)].

At 1312, the GPU may sort the plurality of primitives in a primitive depth order based on the depth value for each of the plurality of primitives, as described in connection with the examples in FIGS. 1-12. For example, as described in 1260 of FIG. 12, GPU 1202 may sort the plurality of primitives in a primitive depth order based on the depth value for each of the plurality of primitives. Further, step 1312 may be performed by processing unit 120 in FIG. 1.

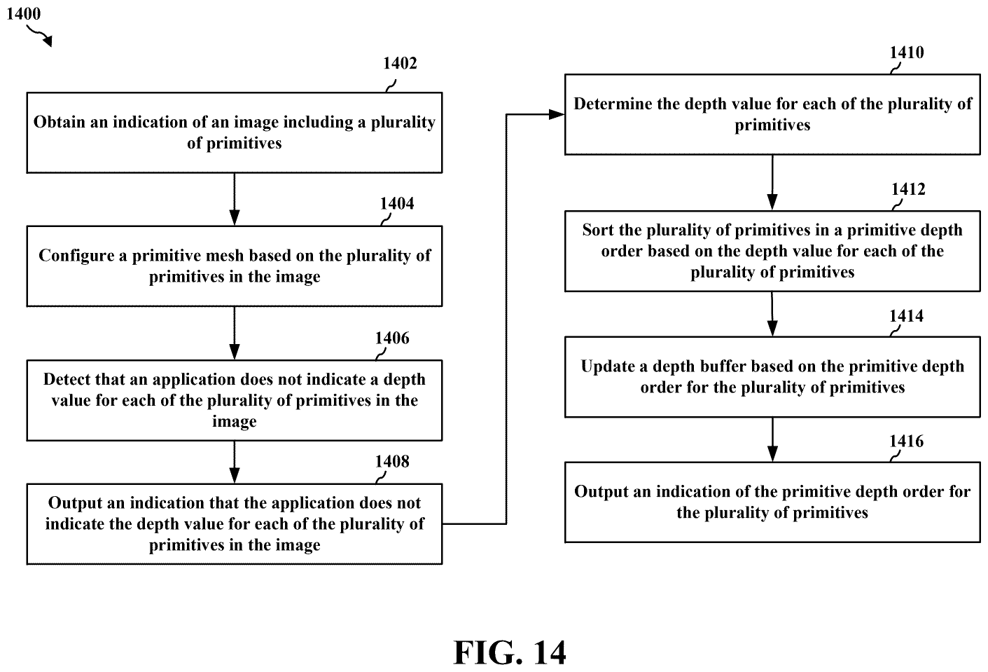

FIG. 14 is a flowchart 1400 of an example method of graphics processing in accordance with one or more techniques of this disclosure. The method may be performed by a GPU (e.g., a GPU, a GPU component, another graphics processor, a CPU, a CPU component, or another central processor), a CPU (e.g., a CPU, a cache at a CPU, a CPU component, another central processor, a GPU, a GPU component, or another graphics processor), an application, a game, a display driver integrated circuit (DDIC), an apparatus for graphics processing, a wireless communication device, and/or any apparatus that may perform graphics processing as used in connection with the examples of FIGS. 1-12.

At 1402, the GPU may obtain, from an application, an indication of an image including a plurality of primitives, as described in connection with the examples in FIGS. 1-12. For example, as described in 1210 of FIG. 12, GPU 1202 may obtain, from an application, an indication of an image including a plurality of primitives. Further, step 1402 may be performed by processing unit 120 in FIG. 1. For example, GPU 1202 may receive indication 1212 from application 1204 or a GPU/CPU.

At 1404, the GPU may configure a primitive mesh based on the plurality of primitives in the image, where the image is a two-dimensional (2D) image or a three-dimensional (3D) image, as described in connection with the examples in FIGS. 1-12. For example, as described in 1220 of FIG. 12, GPU 1202 may configure a primitive mesh based on the plurality of primitives in the image, where the image is a two-dimensional (2D) image or a three-dimensional (3D) image. Further, step 1404 may be performed by processing unit 120 in FIG. 1.

At 1406, the GPU may detect that the application does not indicate a depth value for each of the plurality of primitives in the image, as described in connection with the examples in FIGS. 1-12. For example, as described in 1230 of FIG. 12, GPU 1202 may detect that the application does not indicate a depth value for each of the plurality of primitives in the image. Further, step 1406 may be performed by processing unit 120 in FIG. 1. In some aspects, detecting that the application does not indicate the depth value for each of the plurality of primitives may comprise: detecting, via a graphics processing unit (GPU) driver at a GPU, that the application does not indicate the depth value for each of the plurality of primitives, and the depth value for each of the plurality of primitives may be configured to be disabled at the application.

At 1408, the GPU may output an indication that the application does not indicate the depth value for each of the plurality of primitives in the image, as described in connection with the examples in FIGS. 1-12. For example, as described in 1240 of FIG. 12, GPU 1202 may output an indication that the application does not indicate the depth value for each of the plurality of primitives in the image. Further, step 1408 may be performed by processing unit 120 in FIG. 1. For example, GPU 1202 may transmit indication 1242 to application 1204 or a GPU/CPU. Also, for example, GPU 1202 may store indication 1244 in memory 1206.

At 1410, the GPU may determine, based on the detection, the depth value for each of the plurality of primitives, as described in connection with the examples in FIGS. 1-12. For example, as described in 1250 of FIG. 12, GPU 1202 may determine, based on the detection, the depth value for each of the plurality of primitives. Further, step 1410 may be performed by processing unit 120 in FIG. 1. In some aspects, determining the depth value for each of the plurality of primitives may comprise: determining the depth value for each of the plurality of primitives via hardware at a graphics processing unit (GPU). Also, determining the depth value for each of the plurality of primitives may comprise: determining the depth value for each of the plurality of primitives based on a primitive identifier (ID) for each of the plurality of primitives. Further, determining the depth value for each of the plurality of primitive may comprise: obtaining, from a depth block at the GPU, the primitive ID for each of the plurality of primitives; and assigning the primitive ID for each of the plurality of primitives as the depth value for each of the plurality of primitives. In some aspects, the assignment of the primitive ID may be based on a sequence order of the plurality of primitives, where each primitive in the plurality of primitives that is a current primitive in the sequence order for a corresponding depth value may be assigned the corresponding depth value, where the depth block may be a low-resolution Z (LRZ) depth block, and where the depth value may be an LRZ depth value.

In some aspects, determining the depth value for each of the plurality of primitives may comprise: determining the depth value for each of the plurality of primitives based on a counter identifier (ID) for each of the plurality of primitives. Also, determining the depth value for each of the plurality of primitives may comprise: associating a counter ID for each tile that is touched by each of the plurality of primitives; incrementing a value of the counter ID based on a sequence order of the plurality of primitives; and updating a depth buffer based on the incremented value of the counter ID for each of the plurality of primitives. Further, determining the depth value for each of the plurality of primitives further may comprise: decrementing the value of the counter ID for each tile that is touched by each of the plurality of primitives; rejecting, based on the value of the counter ID being non-zero, a corresponding primitive of the plurality of primitives for each tile; and accepting, based on the value of the counter ID being equal to zero, the corresponding primitive of the plurality of primitives for each tile.

Additionally, in some aspects, determining the depth value for each of the plurality of primitives may comprise: determining the depth value for each of the plurality of primitives via a compiler at a graphics processing unit (GPU) or software at the GPU. Also, determining the depth value for each of the plurality of primitives may comprise: determining the depth value for each of the plurality of primitives based on a primitive identifier (ID) for each of the plurality of primitives. In some instances, the depth value for each of the plurality of primitives may be equal to: [1−(primitive ID/divisor factor)]. Also, determining the depth value for each of the plurality of primitives may comprise: determining the depth value for each of the plurality of primitives based on a vertex identifier (ID) for each vertex of each of the plurality of primitives. The depth value for each of the plurality of primitives may be equal to: [1−(vertex ID/divisor factor)].

At 1412, the GPU may sort the plurality of primitives in a primitive depth order based on the depth value for each of the plurality of primitives, as described in connection with the examples in FIGS. 1-12. For example, as described in 1260 of FIG. 12, GPU 1202 may sort the plurality of primitives in a primitive depth order based on the depth value for each of the plurality of primitives. Further, step 1412 may be performed by processing unit 120 in FIG. 1.

At 1414, the GPU may update a depth buffer based on the primitive depth order for the plurality of primitives, where the depth buffer is a low-resolution Z (LRZ) depth buffer, where the depth value is an LRZ depth value, as described in connection with the examples in FIGS. 1-12. For example, as described in 1270 of FIG. 12, GPU 1202 may update a depth buffer based on the primitive depth order for the plurality of primitives, where the depth buffer is a low-resolution Z (LRZ) depth buffer, where the depth value is an LRZ depth value. Further, step 1414 may be performed by processing unit 120 in FIG. 1.

At 1416, the GPU may output an indication of the primitive depth order for the plurality of primitives, as described in connection with the examples in FIGS. 1-12. For example, as described in 1280 of FIG. 12, GPU 1202 may output an indication of the primitive depth order for the plurality of primitives. Further, step 1416 may be performed by processing unit 120 in FIG. 1. In some aspects, outputting the indication of the primitive depth order for the plurality of primitives may comprise: transmitting the indication of the primitive depth order for the plurality of primitives. For example, GPU 1202 may transmit indication 1282 to application 1204 or a GPU/CPU. Also, outputting the indication of the primitive depth order for the plurality of primitives may comprise: storing the indication of the primitive depth order for the plurality of primitives. For example, GPU 1202 may store indication 1284 in memory 1206.

In configurations, a method or an apparatus for data or graphics processing is provided. The apparatus may be a GPU (or other graphics processor), a CPU (or other central processor), an application, a game, a DDIC, an apparatus for graphics processing, and/or some other processor that may perform data or graphics processing. In aspects, the apparatus may be the processing unit 120 within the device 104, or may be some other hardware within the device 104 or another device. The apparatus, e.g., processing unit 120, may include means for obtaining, from an application, an indication of an image including a plurality of primitives. The apparatus, e.g., processing unit 120, may also include means for detecting that the application does not indicate a depth value for each of the plurality of primitives in the image. The apparatus, e.g., processing unit 120, may also include means for determining, based on the detection, the depth value for each of the plurality of primitives. The apparatus, e.g., processing unit 120, may also include means for sorting the plurality of primitives in a primitive depth order based on the depth value for each of the plurality of primitives. The apparatus, e.g., processing unit 120, may also include means for updating a depth buffer based on the primitive depth order for the plurality of primitives, where the depth buffer is a low-resolution Z (LRZ) depth buffer, and where the depth value is an LRZ depth value. The apparatus, e.g., processing unit 120, may also include means for configuring a primitive mesh based on the plurality of primitives in the image, where the image is a two-dimensional (2D) image or a three-dimensional (3D) image. The apparatus, e.g., processing unit 120, may also include means for outputting an indication that the application does not indicate the depth value for each of the plurality of primitives in the image. The apparatus, e.g., processing unit 120, may also include means for outputting an indication of the primitive depth order for the plurality of primitives.

The subject matter described herein may be implemented to realize one or more benefits or advantages. For instance, the described graphics processing techniques may be used by a GPU, a CPU, a central processor, or some other processor that may perform graphics processing to implement the sorting techniques described herein. This may also be accomplished at a low cost compared to other graphics processing techniques. Moreover, the graphics processing techniques herein may improve or speed up graphics processing or execution. Further, the graphics processing techniques herein may improve resource or data utilization and/or resource efficiency. Additionally, aspects of the present disclosure may utilize sorting techniques in order to improve memory bandwidth efficiency and/or increase processing speed at a GPU, a CPU, or a DPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration. ” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is an apparatus for graphics processing, including at least one memory and at least one processor coupled to the at least one memory and, based at least in part on information stored in the at least one memory, the at least one processor, individually or in any combination, is configured to: obtain, from an application, an indication of an image including a plurality of primitives; detect that the application does not indicate a depth value for each of the plurality of primitives in the image; determine, based on the detection, the depth value for each of the plurality of primitives; and sort the plurality of primitives in a primitive depth order based on the depth value for each of the plurality of primitives.
Aspect 2 is the apparatus of aspect 1, wherein to determine the depth value for each of the plurality of primitives, the at least one processor, individually or in any combination, is configured to: determine the depth value for each of the plurality of primitives via hardware at a graphics processing unit (GPU).
Aspect 3 is the apparatus of aspect 2, wherein to determine the depth value for each of the plurality of primitives, the at least one processor, individually or in any combination, is configured to: determine the depth value for each of the plurality of primitives based on a primitive identifier (ID) for each of the plurality of primitives.
Aspect 4 is the apparatus of aspect 3, wherein to determine the depth value for each of the plurality of primitive, the at least one processor, individually or in any combination, is configured to: obtain, from a depth block at the GPU, the primitive ID for each of the plurality of primitives; and assign the primitive ID for each of the plurality of primitives as the depth value for each of the plurality of primitives.
Aspect 5 is the apparatus of aspect 4, wherein the assignment of the primitive ID is based on a sequence order of the plurality of primitives, wherein each primitive in the plurality of primitives that is a current primitive in the sequence order for a corresponding depth value is assigned the corresponding depth value, wherein the depth block is a low-resolution Z (LRZ) depth block or a fine resolution Z depth block, and wherein the depth value is an LRZ depth value or a fine resolution Z depth value
Aspect 6 is the apparatus of any of aspects 2 to 5, wherein to determine the depth value for each of the plurality of primitives, the at least one processor, individually or in any combination, is configured to: determine the depth value for each of the plurality of primitives based on a counter identifier (ID) for each of the plurality of primitives.
Aspect 7 is the apparatus of aspect 6, wherein to determine the depth value for each of the plurality of primitives, the at least one processor, individually or in any combination, is configured to: associate a counter ID for each tile that is touched by each of the plurality of primitives; increment a value of the counter ID based on a sequence order of the plurality of primitives; and update a depth buffer based on the incremented value of the counter ID for each of the plurality of primitives.
Aspect 8 is the apparatus of aspect 7, wherein to determine the depth value for each of the plurality of primitives, the at least one processor, individually or in any combination, is further configured to: decrement the value of the counter ID for each tile that is touched by each of the plurality of primitives; reject, based on the value of the counter ID being non-zero, a corresponding primitive of the plurality of primitives for each tile; and accept, based on the value of the counter ID being equal to zero, the corresponding primitive of the plurality of primitives for each tile.
Aspect 9 is the apparatus of any of aspects 1 to 8, wherein to determine the depth value for each of the plurality of primitives, the at least one processor, individually or in any combination, is configured to: determine the depth value for each of the plurality of primitives via a compiler at a graphics processing unit (GPU) or software at the GPU
Aspect 10 is the apparatus of aspect 9, wherein to determine the depth value for each of the plurality of primitives, the at least one processor, individually or in any combination, is configured to: determine the depth value for each of the plurality of primitives based on a primitive identifier (ID) for each of the plurality of primitives.
Aspect 11 is the apparatus of aspect 10, wherein the depth value for each of the plurality of primitives is equal to: [1−(primitive ID/divisor factor)].
Aspect 12 is the apparatus of any of aspects 9 to 11, wherein to determine the depth value for each of the plurality of primitives, the at least one processor, individually or in any combination, is configured to: determine the depth value for each of the plurality of primitives based on a vertex identifier (ID) for each vertex of each of the plurality of primitives.
Aspect 13 is the apparatus of aspect 12, wherein the depth value for each of the plurality of primitives is equal to: [1−(vertex ID/divisor factor)].
Aspect 14 is the apparatus of any of aspects 1 to 13, wherein the at least one processor, individually or in any combination, is further configured to: update a depth buffer based on the primitive depth order for the plurality of primitives, wherein the depth buffer is a low-resolution Z (LRZ) depth buffer, and wherein the depth value is an LRZ depth value.
Aspect 15 is the apparatus of any of aspects 1 to 14, wherein the at least one processor, individually or in any combination, is further configured to: configure a primitive mesh based on the plurality of primitives in the image, wherein the image is a two-dimensional (2D) image or a three-dimensional (3D) image.
Aspect 16 is the apparatus of any of aspects 1 to 15, wherein the at least one processor, individually or in any combination, is further configured to: output an indication that the application does not indicate the depth value for each of the plurality of primitives in the image.
Aspect 17 is the apparatus of any of aspects 1 to 16, wherein to detect that the application does not indicate the depth value for each of the plurality of primitives, the at least one processor, individually or in any combination, is configured to: detect, via a graphics processing unit (GPU) driver at a GPU, that the application does not indicate the depth value for each of the plurality of primitives, and wherein the depth value for each of the plurality of primitives is configured to be disabled at the application.
Aspect 18 is the apparatus of any of aspects 1 to 17, wherein the at least one processor, individually or in any combination, is further configured to: output an indication of the primitive depth order for the plurality of primitives.
Aspect 19 is the apparatus of aspect 18, wherein to output the indication of the primitive depth order for the plurality of primitives, the at least one processor, individually or in any combination, is configured to: transmit the indication of the primitive depth order for the plurality of primitives; or store the indication of the primitive depth order for the plurality of primitives.
Aspect 20 is the apparatus of aspect 19, further including (i.e., comprising) at least one of an antenna or a transceiver coupled to the at least one processor, wherein to transmit the indication of the primitive depth order for the plurality of primitives, the at least one processor, individually or in any combination, is configured to: transmit, via at least one of the antenna or the transceiver, the indication of the primitive depth order for the plurality of primitives.
Aspect 21 is the apparatus of any of aspects 1 to 19, wherein the apparatus is a wireless communication device.
Aspect 22 is a method of graphics processing for implementing any of aspects 1 to 21.
Aspect 23 is an apparatus for graphics processing including means for implementing any of aspects 1 to 21.
Aspect 24 is a computer-readable medium (e.g., a non-transitory computer-readable medium) storing computer executable code (e.g., code for graphics processing), the code when executed by at least one processor causes the at least one processor to implement any of aspects 1 to 21.

What is claimed is:

1. An apparatus for graphics processing, comprising:
at least one memory; and
at least one processor coupled to the at least one memory and, based at least in part on information stored in the at least one memory, the at least one processor, individually or in any combination, is configured to:
obtain, from an application, an indication of an image including a plurality of primitives;
detect that the application does not indicate a depth value for each of the plurality of primitives in the image;
determine, based on the detection, the depth value for each of the plurality of primitives; and
sort the plurality of primitives in a primitive depth order based on the depth value for each of the plurality of primitives.

2. The apparatus of claim 1, wherein to determine the depth value for each of the plurality of primitives, the at least one processor, individually or in any combination, is configured to: determine the depth value for each of the plurality of primitives via hardware at a graphics processing unit (GPU).

3. The apparatus of claim 2, wherein to determine the depth value for each of the plurality of primitives, the at least one processor, individually or in any combination, is configured to: determine the depth value for each of the plurality of primitives based on a primitive identifier (ID) for each of the plurality of primitives.

4. The apparatus of claim 3, wherein to determine the depth value for each of the plurality of primitive, the at least one processor, individually or in any combination, is configured to:
obtain, from a depth block at the GPU, the primitive ID for each of the plurality of primitives; and
assign the primitive ID for each of the plurality of primitives as the depth value for each of the plurality of primitives.

5. The apparatus of claim 4, wherein the assignment of the primitive ID is based on a sequence order of the plurality of primitives, wherein each primitive in the plurality of primitives that is a current primitive in the sequence order for a corresponding depth value is assigned the corresponding depth value, wherein the depth block is a low-resolution Z (LRZ) depth block or a fine resolution Z depth block, and wherein the depth value is an LRZ depth value or a fine resolution Z depth value.

6. The apparatus of claim 2, wherein to determine the depth value for each of the plurality of primitives, the at least one processor, individually or in any combination, is configured to: determine the depth value for each of the plurality of primitives based on a counter identifier (ID) for each of the plurality of primitives.

7. The apparatus of claim 6, wherein to determine the depth value for each of the plurality of primitives, the at least one processor, individually or in any combination, is configured to:
associate a counter ID for each tile that is touched by each of the plurality of primitives;
increment a value of the counter ID based on a sequence order of the plurality of primitives; and
update a depth buffer based on the incremented value of the counter ID for each of the plurality of primitives.

8. The apparatus of claim 7, wherein to determine the depth value for each of the plurality of primitives, the at least one processor, individually or in any combination, is further configured to:
decrement the value of the counter ID for each tile that is touched by each of the plurality of primitives;
reject, based on the value of the counter ID being non-zero, a corresponding primitive of the plurality of primitives for each tile; and
accept, based on the value of the counter ID being equal to zero, the corresponding primitive of the plurality of primitives for each tile.

9. The apparatus of claim 1, wherein to determine the depth value for each of the plurality of primitives, the at least one processor, individually or in any combination, is configured to: determine the depth value for each of the plurality of primitives via a compiler at a graphics processing unit (GPU) or software at the GPU.

10. The apparatus of claim 9, wherein to determine the depth value for each of the plurality of primitives, the at least one processor, individually or in any combination, is configured to: determine the depth value for each of the plurality of primitives based on a primitive identifier (ID) for each of the plurality of primitives.

11. The apparatus of claim 10, wherein the depth value for each of the plurality of primitives is equal to: [1−(primitive ID/divisor factor)].

12. The apparatus of claim 9, wherein to determine the depth value for each of the plurality of primitives, the at least one processor, individually or in any combination, is configured to: determine the depth value for each of the plurality of primitives based on a vertex identifier (ID) for each vertex of each of the plurality of primitives.

13. The apparatus of claim 12, wherein the depth value for each of the plurality of primitives is equal to: [1−(vertex ID/divisor factor)].

14. The apparatus of claim 1, wherein the at least one processor, individually or in any combination, is further configured to:
update a depth buffer based on the primitive depth order for the plurality of primitives, wherein the depth buffer is a low-resolution Z (LRZ) depth buffer, and wherein the depth value is an LRZ depth value.

15. The apparatus of claim 1, wherein the at least one processor, individually or in any combination, is further configured to:
configure a primitive mesh based on the plurality of primitives in the image, wherein the image is a two-dimensional (2D) image or a three-dimensional (3D) image.

16. The apparatus of claim 1, wherein the at least one processor, individually or in any combination, is further configured to:
output an indication that the application does not indicate the depth value for each of the plurality of primitives in the image.

17. The apparatus of claim 1, wherein to detect that the application does not indicate the depth value for each of the plurality of primitives, the at least one processor, individually or in any combination, is configured to: detect, via a graphics processing unit (GPU) driver at a GPU, that the application does not indicate the depth value for each of the plurality of primitives, and wherein the depth value for each of the plurality of primitives is configured to be disabled at the application.

18. The apparatus of claim 1, wherein the at least one processor, individually or in any combination, is further configured to:
output an indication of the primitive depth order for the plurality of primitives.

19. A method of graphics processing, comprising:
obtaining, from an application, an indication of an image including a plurality of primitives;
detecting that the application does not indicate a depth value for each of the plurality of primitives in the image;
determining, based on the detection, the depth value for each of the plurality of primitives; and
sorting the plurality of primitives in a primitive depth order based on the depth value for each of the plurality of primitives.

20. A computer-readable medium storing computer executable code for graphics processing, the code when executed by at least one processor causes the at least one processor to:
obtain, from an application, an indication of an image including a plurality of primitives;
detect that the application does not indicate a depth value for each of the plurality of primitives in the image;
determine, based on the detection, the depth value for each of the plurality of primitives; and
sort the plurality of primitives in a primitive depth order based on the depth value for each of the plurality of primitives.
